(19) United States
(12) Patent Application Publication
(10) Pub. No.: US 2015/0071192 A1
(43) Pub. Date: Mar. 12, 2015

(54) Carrier Aggregation in Communications

(71) Applicants: Jani Matti Johannes Moilanen, Helsinki (FI); Antii Anton Toskala, Espoo (FI)

(72) Inventors: Jani Matti Johannes Moilanen, Helsinki (FI); Antii Anton Toskala, Espoo (FI)

(21) Appl. No.: 14/373,117

(22) PCT Filed: Jan. 19, 2012
(86) PCT No.: PCT/EP2012/050808

§ 371 Date: Oct. 3, 2014

(51) Int. Cl. H04W 76/02; H04W 72/08

(52) U.S. Cl. CPC H04W 76/02; H04W 72/087
USPC 370/329

(57) ABSTRACT

A legacy base station receives, from a radio network controller, information on the amount of radio network resources that is available to be reserved for user terminals utilizing LTE-HSPA carrier aggregation. The legacy base station also receives a request directly via an interface from an LTE base station to perform a setup of a connection between the LTE base station and a user terminal by utilizing LTE-HSPA carrier aggregation. Based on the request, the legacy base station checks the received information in order to decide whether or not to grant the LTE base station a permission to set up the connection between the LTE base station and the user terminal by utilizing LTE-HSPA carrier aggregation.

### FIELD OF THE INVENTION

The exemplary and non-limiting embodiments of this invention relate generally to wireless communications networks, and more particularly to traffic management.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Admission control (AC) relates to management of available resources in a network cell. Whenever a request is made for resources at bearer setup, bearer re-negotiation and/or handover, a decision process determines an actual allocation made. The decision may be based on available resources, the state of currently allocated resources, system load and terminal capabilities.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise a method, apparatuses and a computer program product as defined in the independent claims. Further embodiments of the invention are disclosed in the dependent claims.

An aspect of the invention relates to a method comprising receiving, in a network apparatus, information on the amount of radio network resources that is available to be reserved for user terminals utilizing LTE-HSPA carrier aggregation; receiving, in the network apparatus, a request directly via an interface from an LTE base station to perform a setup of a connection between the LTE base station and a user terminal by utilizing LTE-HSPA carrier aggregation; based on the request, checking, in the network apparatus, the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation, wherein if it is decided, in the network apparatus, to grant the LTE base station the permission to set up the connection between the LTE base station and the user terminal by utilizing LTE-HSPA carrier aggregation, a grant message is transmitted from the network apparatus to the LTE base station, the grant message granting the LTE base station the permission to set up the connection between the LTE base station and the user terminal by utilizing LTE-HSPA carrier aggregation.

A further aspect of the invention relates to an apparatus comprising a communication control circuitry configured to receive, information on the amount of radio network resources that is available to be reserved for user terminals utilizing LTE-HSPA carrier aggregation; receive a request directly via an interface from an LTE base station to perform a setup of a connection between the LTE base station and a user terminal by utilizing LTE-HSPA carrier aggregation; based on the request, check the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation; transmit a grant message to the LTE base station, if it is decided that the LTE base station is granted the permission to set up the connection between the LTE base station and the user terminal by utilizing LTE-HSPA carrier aggregation, the grant message granting the LTE base station said permission.

A still further aspect of the invention relates to an apparatus comprising a communication control circuitry configured to receive, information on the amount of radio network resources that is available to be reserved for user terminals utilizing LTE-HSPA carrier aggregation; receive a request directly via an interface from an LTE base station to perform a setup of a connection between the LTE base station and a user terminal by utilizing LTE-HSPA carrier aggregation; based on the request, check the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation; transmit a grant message to the LTE base station, if it is decided that the LTE base station is granted the permission to set up the connection between the LTE base station and the user terminal by utilizing LTE-HSPA carrier aggregation, the grant message granting the LTE base station said permission.

A still further aspect of the invention relates to an apparatus comprising at least one processor; and at least one memory including a computer program code, wherein the at least one memory and the computer program code are configured to, with the at least one processor, cause the apparatus to transmit, to a legacy base station, information on the amount of radio network resources that is available to be reserved for user terminals utilizing LTE-HSPA carrier aggregation, in order the legacy base station to be able to decide, based on a request received directly via an interface in the legacy base station from an LTE base station, whether or not to grant an LTE base station a permission to set up the connection between the LTE base station and a user terminal by utilizing LTE-HSPA carrier aggregation.

A still further aspect of the invention relates to an apparatus comprising at least one processor; and at least one memory including a computer program code, wherein the at least one memory and the computer program code are configured to, with the at least one processor, cause the apparatus to transmit directly via an interface to a legacy base station a request to perform a setup of a connection between the apparatus and a user terminal by utilizing LTE-HSPA carrier aggregation; receive a grant message from the legacy base station, the grant message granting the apparatus a permission to set up the connection between the apparatus and the user terminal by utilizing LTE-HSPA carrier aggregation based on the amount of radio network resources that is available to be reserved for the user terminals utilizing LTE-HSPA carrier aggregation; and based on the grant message, set up the connection between the apparatus and the user terminal by utilizing LTE-HSPA carrier aggregation.

A still further aspect of the invention relates to computer program product comprising program code means adapted to perform any one of the method steps when the program is run on a computer.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1 shows a simplified block diagram illustrating network interfaces;

FIG. 2 shows a simplified block diagram illustrating exemplary system architecture;

FIG. 3 shows a simplified block diagram illustrating exemplary apparatuses;

FIG. 4 shows a messaging diagram illustrating an exemplary messaging event according to an embodiment;

FIG. 5 shows a schematic diagram of a flow chart illustrating an exemplary embodiment;

FIG. 6 shows a schematic diagram of a flow chart illustrating an exemplary embodiment;

FIG. 7 shows a schematic diagram of a flow chart illustrating an exemplary embodiment.

### DETAILED DESCRIPTION OF SOME EMBODIMENTS

An exemplary embodiment relates to traffic management (e.g. admission control, call dropping) of UEs that apply LTE-HSDPA carrier aggregation (L-H CA). LTE-HSDPA carrier aggregation is a Rel-11 study item proposal which enables L-H CA capable user terminals to receive data simultaneously from HSPA and LTE cells. LTE-HSPA CA enables combining peak data rates and cell edge data rates of HSPA and LTE radio systems. By means of LTE-HSPA CA, fast load balancing between the two radios systems (HSPA, LTE) may be provided, and highest possible spectrum utilization when both LTE and HSPA systems are deployed, may be ensured. Investments made on the existing HSPA infrastructure may thus be protected, as it reduces a pressure to refarm radio spectrum from HSPA to LTE for higher data rates in the LTE radio network.

Frame protocol (FP) refers to a protocol which is used to transport user data frames and/or control data frames between a serving radio network controller (SRNC) and a base station over lub and lur interfaces.

A concept of two co-located base stations with an interface in between has been considered for use with LTE-HSDPA carrier aggregation, in which L-H CA architecture LTE side (i.e. eNB) is to be the master that controls joint scheduling for UEs applying LTE-HSDPA carrier aggregation. Traffic management (admission control, call dropping) for HSDPA is, however, handled by RNC. Therefore, a solution for RNC to be able to perform traffic management also for L-H CA UEs is required, as well as direct interaction between RNC and eNB.

A new interface (called lur-I) has been proposed between eNB and RNC for handling admission control for LTE-HSDPA CA, wherein (via lur-I) eNB requests permission from RNC to setup an LTE-HSDPA CA connection and RNC may either reject the connection setup (e.g. due to lack of resources) or grant it. However, RNC then needs to be able to handle large quantities of LTE eNBs (hundreds, if not thousands) in addition to the burden caused by legacy HSPA node-Bs; thus the feasibility of such a solution (direct interaction between RNC and eNB) may be a concern.

An exemplary embodiment involves extending an existing lub interface (between RNC and node-B) and introducing a new interface between eNB and node-B (which is introduced with LTE-HSDPA CA).

In an exemplary embodiment, RNC informs node-B on how much resources node-B is able to reserve for L-H CA UEs. eNB requests permission directly from node-B to setup a L-H CA connection (with certain QoS requirements). Node-B grants/denies the L-H CA connection setup request (based on the information (i.e. information on resources available to be reserved by node-B) it has received from RNC and based on the knowledge on the resources used by the other UEs).

The information on the available L-H CA resources may be sent by RNC in an unsolicited manner and/or in response to a request sent by node-B. In the latter case, node-B may also provide information on a desired amount of resources (based QoS information it has received from eNB). Also a combination of the two schemes may be possible (node-B indicates to RNC that there is an attempt to set up an L-H CA connection, and RNC starts to send the resource information in an unsolicited manner until node-B indicates that it does not have active L-H CA connections anymore). The available resources may be expressed by RNC as a fraction of node-B's capacity and/or in absolute terms as guaranteed throughput (Mbits/s) (that is to be left to HSPA users). In case of congestion, RNC may also reduce the amount of resources reserved for L-H CA UEs. If the remaining resources are not sufficient anymore for fulfilling L-H CA UEs' QoS requirements, node-B informs eNB which then may either drop L-H CA calls or update QoS parameters of the L-H CA calls. Even if RNC reserves some resources for L-H CA, those resources may also be used for HSDPA-only UEs, if all of those resources are not used for L-H CA transmissions. Similarly, node-B may allow eNB to use more resources if there are unused resources. In an extreme case, RNC does not grant any resources for L-H CA UEs, but relies on node-B to allow the use of L-H CA if there are unused resources in node-B.

An exemplary embodiment enables implementation of L-H CA without introducing an interface such as lur-I) between RNC and eNB, thus enabling simpler (and less costly) RNC implementations. Information on node-B hardware capacity limitations may not always be available in RNC, thus an exemplary embodiment allows a more reliable setting up of the LTE/HSDPA CA operation. Direct connection setup on a base station site is faster than when going via RNC, thus the ability to react to bursty traffic needs may be improved. In an exemplary embodiment, necessary parameters may be available on the base station site, such as HS-SCCH codes, power available for HSPDA etc. which may be provided to eNB directly (as they are or as a container to be provided to UE). Those parameters may otherwise be common to each UE, except for H-RNTI which is an UE-specific parameter. It may, however, be possible to reserve a pool of H-RNTIs for L-H CA UEs which node-B then allocates/de-allocates when new L-H CA connections are set up/terminated. Thus RNC may be omitted from a detailed parameterization process.

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network element, server, corresponding component, and/or to any communication system or any combination of different communication systems that support a carrier aggregation. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

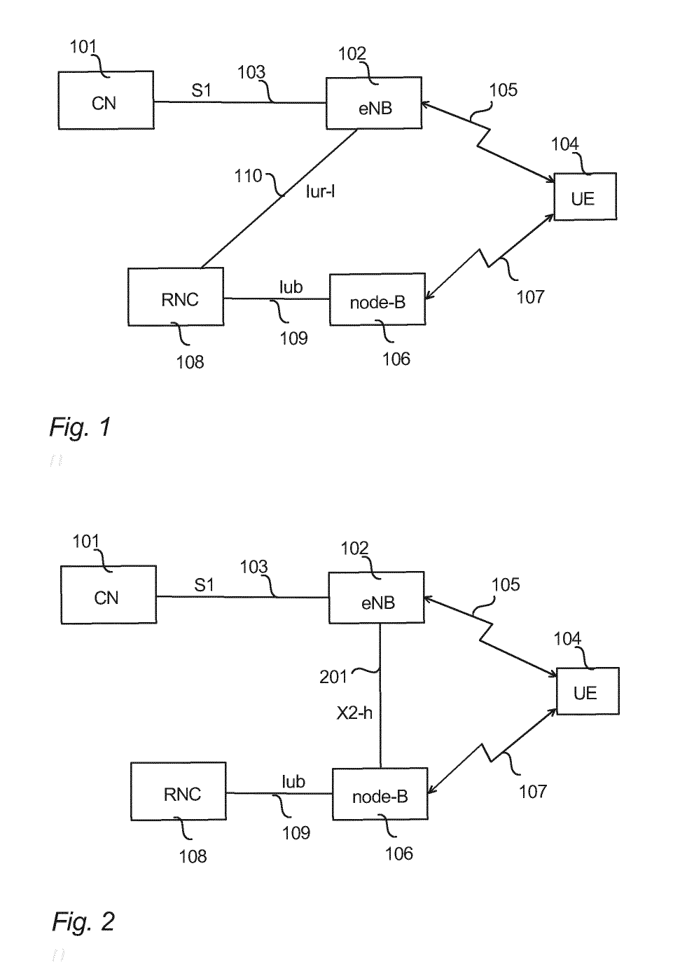

With reference to FIG. 1, let us examine an example of a prior art radio system. In this example, the radio system is based on LTE network elements. A general architecture of a communication system is illustrated in FIG. 1. The radio system of FIG. 1 comprises a core network node 101 of a network operator. The core network node 101 may include e.g. a mobile switching centre (MSC), MSC server (MSS), mobility management entity (MME), gateway GPRS support node (GGSN), serving GPRS support node (SGSN), home location register (HLR), home subscriber server (HSS), visitor location register (VLR), or any other network element, or a combination of network elements. FIG. 1 shows the core network node 101 operatively connected to a network element 102. The network element 102 may include an LTE base station (eNB), or any other network element or a combination of network elements. The network node 101 and the radio network node 102 are connected to each other via a connection 103 or via one or more further network elements. The interface between the core network node 101 and the radio network node 102 may be called an S1 interface. In FIG. 1, the radio network node 102 that may also be called eNB (enhanced node-B, evolved node-B) of the radio system hosts the functions for radio resource management in a public land mobile network. FIG. 1 shows one or more user equipment 104 located in the service area of the radio network node 102. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 1, the user equipment 104 is capable of connecting to the radio network node 102 via a connection 105. In the example situation of FIG. 1, the user equipment 104 is also capable of connecting to a further radio network node 106 via a connection 107. The further radio network element 106 may include a legacy base station (node-B), or any other network element or a combination of network elements. The further radio network node 106 is connected to a network node 108 via a connection 109 or via one or more further network elements. The interface between the network node 108 and the radio network node 106 may be called an lub interface. In FIG. 1, the radio network node 106 that may also be called node-B (base station, BTS, BS) of the radio system hosts the functions for radio resource management in a public land mobile network. In FIG. 1, the network node 108 that may also be called a radio network controller (RNC) is connected to the LTE base station 102 via a connection 110. The interface between the radio network controller 108 and the LTE base station 102 may be called an lur-I interface, wherein the lur-I interface between eNB and RNC has been assumed as an alternative interface between eNB and RNC.

In the following, different embodiments will be described using, as an example of a system architecture whereto the embodiments may be applied, without restricting the embodiment to such an architecture, however.

With reference to FIG. 2, let us examine an example of a radio system to which embodiments of the invention can be applied. In this example, the radio system is based on LTE network elements. However, the invention described in these examples is not limited to the LTE radio systems but can also be implemented in other radio systems, such as UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as LTE and UMTS.

A general architecture of a communication system is illustrated in FIG. 2. The exemplary radio system of FIG. 2 comprises The exemplary radio system of FIG. 2 comprises a core network node 101 of a network operator. The core network node 101 may include e.g. a mobile switching centre (MSC), MSC server (MSS), mobility management entity (MME), gateway GPRS support node (GGSN), serving GPRS support node (SGSN), home location register (HLR), home subscriber server (HSS), visitor location register (VLR), or any other network element, or a combination of network elements. FIG. 2 shows the core network node 101 operatively connected to a network element 102. The network element 102 may include an LTE base station (eNB), or any other network element or a combination of network elements. The network node 101 and the radio network node 102 are connected to each other via a connection 103 or via one or more further network elements. The interface between the core network node 101 and the radio network node 102 may be called an S1 interface. In FIG. 2, the radio network node 102 that may also be called eNB (enhanced node-B, evolved node-B) of the radio system hosts the functions for radio resource management in a public land mobile network. FIG. 2 shows one or more user equipment 104 located in the service area of the radio network node 102. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 2, the user equipment 104 is capable of connecting to the radio network node 102 via a connection 105. In the example situation of FIG. 2, the user equipment 104 is also capable of connecting to a further radio network node 106 via a connection 107. The further radio network element 106 may include a legacy base station (node-B), or any other network element or a combination of network elements. The further radio network node 106 is connected to a network node 108 via a connection 109 or via one or more further network elements. The interface between the network node (that may also be called a radio network controller (RNC)) 108 and the radio network node 106 may be called an lub interface. In FIG. 2, the radio network node 106 that may also be called node-B (base station, BTS, BS) of the radio system hosts the functions for radio resource management in a public land mobile network. In FIG. 2, the legacy base station (node-B) 106 is connected to the LTE base station 102 via a connection 201. The interface between the legacy base station (node-B) 106 and the LTE base station 102 may be called an X2-h interface.

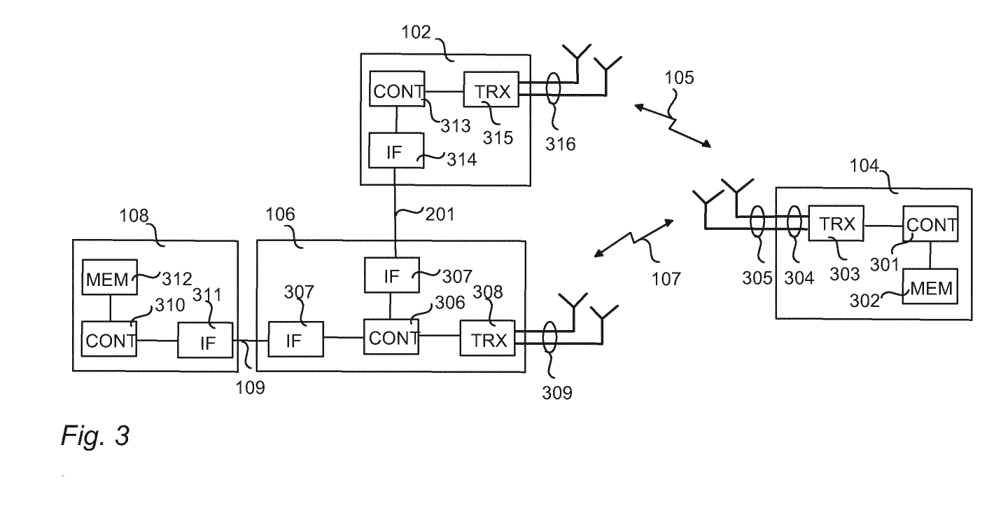

FIG. 3 illustrates examples of apparatuses according to embodiments of the invention. FIG. 3 shows a user equipment 104 located in the area of a radio network node 102, 106. The user equipment 104 is configured to be in connection with the radio network node 102, 106. The user equipment or UE 104 comprises a controller 301 operationally connected to a memory 302 and a transceiver 303. The controller 301 controls the operation of the user equipment 104. The memory 302 is configured to store software and data. The transceiver 303 is configured to set up and maintain a wireless connection 105, 107 to the radio network node 102, 106. The transceiver is operationally connected to a set of antenna ports 304 connected to an antenna arrangement 305. The antenna arrangement 305 may comprise a set of antennas. The number of antennas may be one to four, for example. The number of antennas is not limited to any particular number. The user equipment 104 may also comprise various other components, such as a user interface, camera, and media player. They are not displayed in the figure due to simplicity. The radio network node 106, such as a legacy base station (node-B, BTS, BS), comprises a controller 306 operationally connected to an interface 307, and a transceiver 308. The controller 306 controls the operation of the radio network node 106. The transceiver 308 is configured to set up and maintain a wireless connection to the user equipment 104 within the service area of the radio network node 106. The transceiver 308 is operationally connected to an antenna arrangement 309. The antenna arrangement 309 may comprise a set of antennas. The number of antennas may be two to four, for example. The number of antennas is not limited to any particular number. The radio network node 106 may be operationally connected (directly or indirectly) to another network element 108 of the communication system, such as an radio network controller (RNC). The network element 108 may comprise a controller 310 operationally connected to an interface 311, and a memory 312. The controller 310 controls the operation of the network node 106. The memory 312 is configured to store software and data. In an exemplary embodiment, the radio network node 106 is operationally connected via a connection 201 to a further radio network node 102, such as an LTE base station (eNode-B, eNB). The radio network node 102 comprises a controller 313 operationally connected to an interface 314, and a transceiver 315. The controller 313 controls the operation of the radio network node 102. The transceiver 315 is configured to set up and maintain a wireless connection to the user equipment 104 within the service area of the radio network node 102. The transceiver 315 is operationally connected to an antenna arrangement 316. The antenna arrangement 316 may comprise a set of antennas. The number of antennas may be two to four, for example. The number of antennas is not limited to any particular number. The radio network node 102, 108 may be operationally connected (directly or indirectly) to a further network element (not shown in FIG. 3) of the communication system, such as a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server. The embodiments are not, however, restricted to the network given above as an example, but a person skilled in the art may apply the solution to other communication networks provided with the necessary properties. For example, the connections between different network elements may be realized with internet protocol (IP) connections.

The memory may include volatile and/or non-volatile memory and typically stores content, data, or the like. For example, the memory may store computer program code such as software applications (for example for the detector unit and/or for the adjuster unit) or operating systems, information, data, content, or the like for the processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firm-ware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

User equipment may refer to any user communication device. A term “user equipment” as used herein may refer to any device having a communication capability, such as a wireless mobile terminal, a PDA, tablet, a smart phone, a personal computer (PC), a laptop computer, a desktop computer, etc. For example, the wireless communication terminal may be an UMTS or GSM/EDGE smart mobile terminal having wireless modem. Thus, the application capabilities of the device according to various embodiments of the invention may include native applications available in the terminal, or subsequently installed applications by the user or operator or other entity. The network apparatus 302 may be implemented in any network element, such as a server.

FIG. 3 is a block diagram of an apparatus according to an embodiment of the invention. Although the apparatus has been depicted as one entity, different modules and memory may be implemented in one or more physical or logical entities.

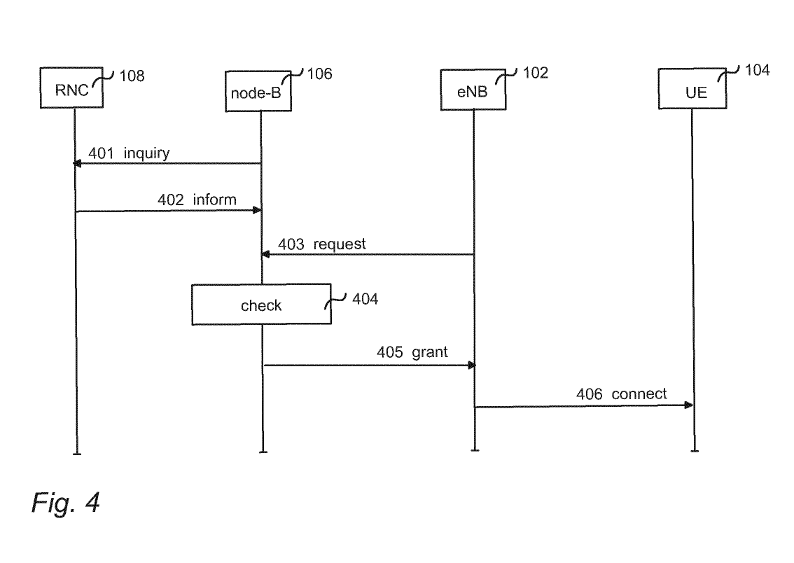

The functionality of the network apparatus 102, 104, 106, 108 is described in more detail below with FIGS. 4 to 7. It should be appreciated that the apparatus 102, 104, 106, 108 may comprise other units used in or for distributed computing and/or data federation. However, they are irrelevant to the actual invention and, therefore, they need not to be discussed in more detail here.

The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminal include a personal computer, a game console, a laptop (a notebook), a personal digital assistant, a mobile station (mobile phone), and a line telephone.

The apparatus 102, 104, 106, 108 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firm-ware or software, implementation may be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it may be communicatively coupled to the processor/computer via various means as is known in the art.

The signalling chart of FIG. 4 illustrates the required signalling. In the example of FIG. 4, a network element 108 which may comprise e.g. a radio network node such as a radio network controller, informs a network apparatus 106 (HSPA-capable base station (node-B)), by sending a message 402 to node-B, how much resources RNC is able to reserve for L-H CA UEs. By sending a message 403 to node-B, eNode-B requests permission directly from node-B to setup an L-H CA connection (with certain QoS requirements). In item 404, node-B checks the information node-B has received from RNC in message 402, in order to decide whether to grant or deny the L-H CA connection setup request sent by eNode-B in message 403. By sending a message 405, node-B grants/denies the L-H CA connection setup request (based on the checking carried out in item 404). If node-B grants the L-H CA connection setup request, the L-H CA connection may be set up between eNode-B and the user terminal 104 via a message 406. The information on available L-H CA resource may be sent in message 402 in an unsolicited manner or as a response to an inquiry 401 received by RNC from node-B. In the latter case, node-B may also provide information on a desired amount of resources (based on QoS information node-B has received from eNode-B). Also a combination of the two schemes is possible (node-B indicates to RNC that there is an attempt to setup an L-H CA connection and RNC starts to send the resource information in an unsolicited manner until node-B indicates that it does not have active L-H CA connections anymore). The available resources may be expressed by RNC as a fraction of node-B's capacity or in absolute terms as a guaranteed throughput (Mbits/s) (that is to be left to HSPA users). In case of congestion, RNC may also reduce the amount of resources reserved for L-H CA UEs (and RNC may inform node-B 106 on the reduction), wherein if the remaining resources are not sufficient anymore to fulfil L-H CA UEs' QoS requirements, node-B may inform eNode-B which may then either initiate reconfiguration in order to stop using L-H CA or in order to update the QoS parameters of L-H CA calls. Even if RNC reserves some resources for L-H CA, those resources may also be used for HSDPA-only UEs if each of them are not used for L-H CA transmissions. Similarly, node-B may allow eNode-B to use more resources if there are unused resources.

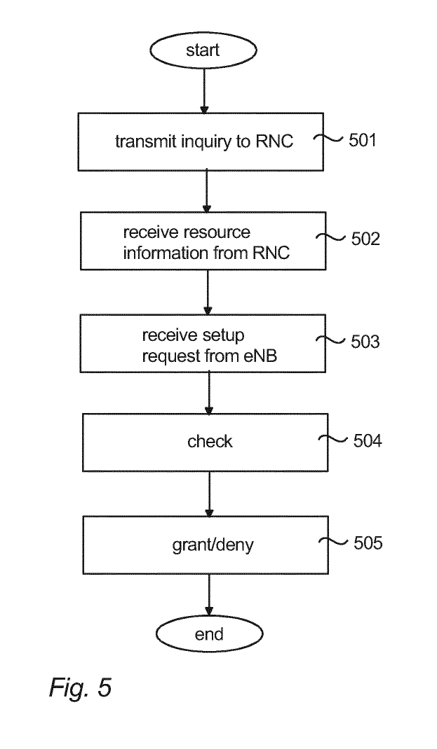

FIG. 5 is a flow chart illustrating an exemplary embodiment. The apparatus 106, which may comprise e.g. a network element (network node, e.g. a legacy base station, node-B), receives, in item 502, from the radio network controller 108 information on how much resources RNC is able to reserve for L-H CA UEs. The apparatus receives, in item 503, directly via the interface 201 from the LTE base station 102, a message requesting permission from the apparatus 106 to setup an L-H CA connection (with certain QoS requirements). In item 504, the apparatus 106 checks the information it has received from RNC in item 502, in order to decide whether to grant or deny the L-H CA connection setup request sent by eNode-B in item 503. By sending, via the interface 201, a message in item 505 the apparatus 106 may grant/deny the L-H CA connection setup request (based on the checking carried out in item 504). The information on available L-H CA resources may be received as a response to an inquiry sent, in item 501, from the apparatus 106 to RNC. The apparatus 106 may also provide information (e.g. in item 501) on a desired amount of resources (based on QoS information the apparatus 106 has received from eNode-B). Also a combination of two schemes is possible (the apparatus 106 indicates to RNC that there is an attempt to setup an L-H CA connection and RNC starts to send the resource information in an unsolicited manner until the apparatus 106 indicates (to RNC) that it does not have active L-H CA connections anymore). If the remaining resources are not sufficient anymore to fulfil L-H CA UEs' QoS requirements, the apparatus 106 may inform eNode-B which may then either drops L-H CA calls or update their QoS parameters. The apparatus 106 may allow eNode-B to use more resources if there are unused resources.

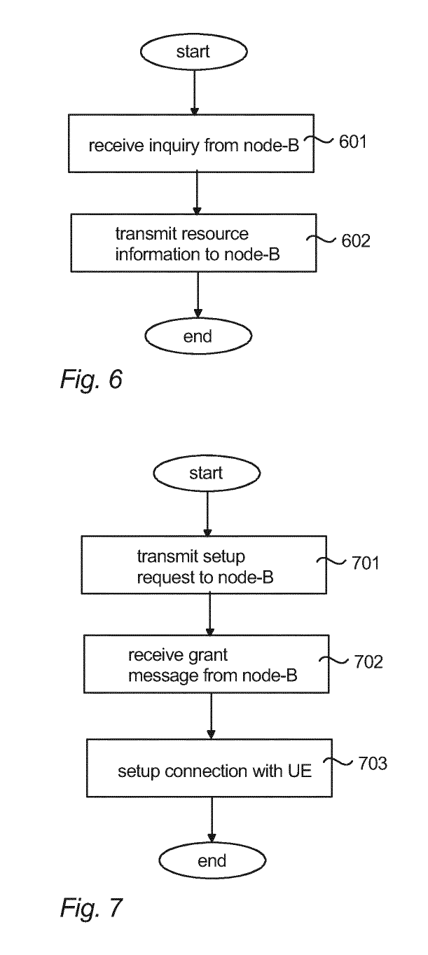

FIG. 6 is a flow chart illustrating an exemplary embodiment. The apparatus 108, which may comprise e.g. a network element (network node, e.g. a radio network controller, RNC), transmits, in item 602, to node-B information on how much resources the apparatus 108 is able to reserve for L-H CA UEs. The information on available L-H CA resource may be sent in item 602 in an unsolicited manner or as a response to an inquiry received, in item 601, in the apparatus 108 from node-B. Information on a desired amount of resources (based on QoS information node-B has received from eNode-B) may also be received from node-B. Also a combination of the two schemes is possible (node-B indicates to RNC that there is an attempt to setup an L-H CA connection and RNC starts to send the resource information in an unsolicited manner until node-B indicates that it does not have active L-H CA connections anymore). In case of congestion, RNC may also reduce the amount of resources reserved for L-H CA UEs (and RNC may inform node-B 106 on the reduction).

FIG. 7 is a flow chart illustrating an exemplary embodiment. The apparatus 102, which may comprise e.g. a network element (network node, e.g. an LTE base station, eNode-B, eNB), transmits, in item 701 a message directly via the interface 201 to node-B requesting permission to setup an L-H CA connection (with certain QoS requirements). If node-B grants the L-H CA connection setup request a grant message is received in the apparatus 102 in item 702 from node-B via the interface 201. If node-B grants the L-H CA connection setup request, the L-H CA connection may be set up between the apparatus 102 and the user terminal 104 in item 703. (If node-B denies the L-H CA connection setup request a deny message may be received via the interface 201 in the apparatus 102 from node-B in item 702, wherein the L-H CA connection is not set up between the apparatus 102 and the user terminal 104 in item 703).

An exemplary embodiment thus enables a situation where an interface between eNB and RNC is not needed anymore. Instead, extra info may be added on the interfaces between node-B and eNB, as well as between RNC and node-B, by the addition of new information elements to an lub and/or eNB/node-B frame protocol. Admission control for LTE-HSPA carrier aggregation may thus be enhanced.

It should be noted that LTE-HSPA carrier aggregation herein may refer to aggregation of LTE and HSDPA carriers in downlink direction (LTE-HSDPA carrier aggregation), as well as LTE and HSUPA carriers in uplink direction (LTE-HSUPA carrier aggregation). The aggregation may occur in both directions, or on only one of the directions. When only one of the directions is aggregated, then the other direction is handled by LTE or HSPA only. For example, when referring to the LTE-HSDPA carrier aggregation, then the uplink direction may be based on using LTE-based uplink only.

Thus, according to an exemplary embodiment, there is provided a method for receiving, in a network apparatus, information on the amount of radio network resources that is available to be reserved for user terminals utilizing LTE-HSPA carrier aggregation; receiving, in the network apparatus, a request directly via an interface from an LTE base station to perform a setup of a connection between the LTE base station and a user terminal by utilizing LTE-HSPA carrier aggregation; based on the request, checking, in the network apparatus, the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation, wherein if it is decided, in the network apparatus, to grant the LTE base station the permission to set up the connection between the LTE base station and the user terminal by utilizing LTE-HSPA carrier aggregation, a grant message is transmitted from the network apparatus to the LTE base station, the grant message granting the LTE base station the permission to set up the connection between the LTE base station and the user terminal by utilizing LTE-HSPA carrier aggregation.

According to another exemplary embodiment, the information on the amount of radio network resources that is available to be reserved for user terminals utilizing LTE-HSPA carrier aggregation is received from a radio network controller as a response to an inquiry sent from the network apparatus.

According to yet another exemplary embodiment, the inquiry indicates a desired amount of resources, the desired amount of resources being based on QoS information received in the apparatus from the LTE base station.

According to yet another exemplary embodiment, an indication is sent from the network apparatus to the radio network controller that there is an attempt to setup a connection between the LTE base station and a user terminal by utilizing LTE-HSPA carrier aggregation, in order the radio network controller to start to send the information on the amount of radio network resources that is available to be reserved for user terminals utilizing LTE-HSPA carrier aggregation in an unsolicited manner until another indication is sent from the network apparatus to the radio network controller that the network apparatus does not have active connections utilizing LTE-HSPA carrier aggregation anymore.

According to yet another exemplary embodiment, the amount of radio network resources that is available to be reserved for user terminals utilizing LTE-HSPA carrier aggregation is expressed as a fraction of the network apparatus's capacity.

According to yet another exemplary embodiment, the amount of radio network resources that is available to be reserved for user terminals utilizing LTE-HSPA carrier aggregation is expressed in absolute terms as a guaranteed data throughput that is to be left to HSPA user terminals.

According to yet another exemplary embodiment, if in case of congestion the amount of radio network resources that is available to be reserved for user terminals utilizing LTE-HSPA carrier aggregation is reduced by the radio network controller, and if the remaining resources are not sufficient to fulfil the user terminals' QoS requirements, an indication is sent from the network apparatus to the LTE base station to cause the LTE base station to initiate reconfiguration in order to stop using LTE-HSPA carrier aggregation or update QoS parameters of the calls that utilize LTE-HSPA carrier aggregation.

According to yet another exemplary embodiment, there is provided an apparatus comprising at least one processor; and at least one memory including a computer program code, wherein the at least one memory and the computer program code are configured to, with the at least one processor, cause the apparatus to receive, information on the amount of radio network resources that is available to be reserved for user terminals utilizing LTE-HSPA carrier aggregation; receive a request directly via an interface from an LTE base station to perform a setup of a connection between the LTE base station and a user terminal by utilizing LTE-HSPA carrier aggregation; based on the request, check the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation; transmit a grant message to the LTE base station, if it is decided that the LTE base station is granted the permission to set up the connection between the LTE base station and the user terminal by utilizing LTE-HSPA carrier aggregation, the grant message granting the LTE base station said permission.

According to yet another exemplary embodiment, the at least one memory and the computer program code are configured to, with the at least one processor, cause the apparatus to receive the information on the amount of radio network resources that is available to be reserved for user terminals utilizing LTE-HSPA carrier aggregation from a radio network controller as a response to an inquiry sent from the apparatus.

According to yet another exemplary embodiment, the at least one memory and the computer program code are configured to, with the at least one processor, cause the apparatus to send an indication to the radio network controller that there is an attempt to setup a connection between the LTE base station and a user terminal by utilizing LTE-HSPA carrier aggregation, in order the radio network controller to start to send the information on the amount of radio network resources that is available to be reserved for user terminals utilizing LTE-HSPA carrier aggregation in an unsolicited manner until another indication is sent from the apparatus to the radio network controller that the apparatus does not have active connections utilizing LTE-HSPA carrier aggregation anymore.

According to yet another exemplary embodiment, the at least one memory and the computer program code are configured to, with the at least one processor, cause the apparatus to, if in case of congestion the amount of radio network resources that is available to be reserved for user terminals utilizing LTE-HSPA carrier aggregation is reduced by the radio network controller, and if the remaining resources are not sufficient to fulfil the user terminals' QoS requirements, send an indication to the LTE base station to cause the LTE base station to initiate reconfiguration in order to stop using LTE-HSPA carrier aggregation or update QoS parameters of the calls that utilize LTE-HSPA carrier aggregation.

According to yet another exemplary embodiment, there is provided an apparatus comprising a legacy base station, such as an HSPA base station node-B.

According to yet another exemplary embodiment, there is provided an apparatus comprising a communication control circuitry configured to receive, information on the amount of radio network resources that is available to be reserved for user terminals utilizing LTE-HSPA carrier aggregation; receive a request directly via an interface from an LTE base station to perform a setup of a connection between the LTE base station and a user terminal by utilizing LTE-HSPA carrier aggregation; based on the request, check the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation; transmit a grant message to the LTE base station, if it is decided that the LTE base station is granted the permission to set up the connection between the LTE base station and the user terminal by utilizing LTE-HSPA carrier aggregation, the grant message granting the LTE base station said permission.

According to yet another exemplary embodiment, there is provided an apparatus comprising at least one processor; and at least one memory including a computer program code, wherein the at least one memory and the computer program code are configured to, with the at least one processor, cause the apparatus to transmit, to a legacy base station, information on the amount of radio network resources that is available to be reserved for user terminals utilizing LTE-HSPA carrier aggregation, in order the legacy base station to be able to decide, based on a request directly received via an interface in the legacy base station from an LTE base station, whether or not to grant an LTE base station a permission to set up the connection between the LTE base station and a user terminal by utilizing LTE-HSPA carrier aggregation.

According to yet another exemplary embodiment, the at least one memory and the computer program code are configured to, with the at least one processor, cause the apparatus to transmit, to the legacy base station, the information on the amount of radio network resources that is available to be reserved for user terminals utilizing LTE-HSPA carrier aggregation, as a response to an inquiry sent from the legacy base station.

According to yet another exemplary embodiment, the inquiry indicates a desired amount of radio network resources, the desired amount of radio network resources being based on QoS information received in the legacy base station from the LTE base station.

According to yet another exemplary embodiment, the at least one memory and the computer program code are configured to, with the at least one processor, cause the apparatus to receive an indication from the legacy base station that there is an attempt to setup a connection between the LTE base station and a user terminal by utilizing LTE-HSPA carrier aggregation; and start to send, to the legacy base station, the information on the amount of radio network resources that is available to be reserved for user terminals utilizing LTE-HSPA carrier aggregation in an unsolicited manner until another indication is received from the legacy base station that the legacy base station does not have active connections utilizing LTE-HSPA carrier aggregation anymore.

According to yet another exemplary embodiment, the at least one memory and the computer program code are configured to, with the at least one processor, cause the apparatus to express the amount of radio network resources that is available to be reserved for user terminals utilizing LTE-HSPA carrier aggregation as a fraction of the legacy base station's capacity.

According to yet another exemplary embodiment, the at least one memory and the computer program code are configured to, with the at least one processor, cause the apparatus to express the amount of radio network resources that is available to be reserved for user terminals utilizing LTE-HSPA carrier aggregation in absolute terms as a guaranteed data throughput that is to be left to HSPA user terminals.

According to yet another exemplary embodiment, the at least one memory and the computer program code are configured to, with the at least one processor, cause the apparatus to reduce, in case of congestion, the amount of radio network resources that is available to be reserved for user terminals utilizing LTE-HSPA carrier aggregation; and inform the legacy base station on the reduction.

According to yet another exemplary embodiment, there is provided an apparatus comprising at least one processor; and at least one memory including a computer program code, wherein the at least one memory and the computer program code are configured to, with the at least one processor, cause the apparatus to transmit directly via an interface to a legacy base station a request to perform a setup of a connection between the apparatus and a user terminal by utilizing LTE-HSPA carrier aggregation; receive a grant message from the legacy base station, the grant message granting the apparatus a permission to set up the connection between the apparatus and the user terminal by utilizing LTE-HSPA carrier aggregation based on the amount of radio network resources that is available to be reserved for the user terminals utilizing LTE-HSPA carrier aggregation; and based on the grant message, set up the connection between the apparatus and the user terminal by utilizing LTE-HSPA carrier aggregation.

According to yet another exemplary embodiment, there is provided a computer program product comprising program code means adapted to perform any one of steps of the method when the program is run on a computer.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

eNB enhanced node-B

L-H CA LTE-HSPA carrier aggregation

LTE long term evolution

CA carrier aggregation

CN core network

UE user equipment

HSDPA high speed downlink packet access

HSUPA high speed uplink packet access

HSPA high speed packet access

H-RNTI HS-DSCH radio network temporary identifier

HS-SCCH high speed shared control channel

HS-DSCH high speed downlink shared channel

RNC radio network controller

QoS quality of service

FP frame protocol

1. A method for traffic management in a communications system, characterized by
receiving, in a network apparatus, information on the amount of radio network resources that is available to be reserved for user terminals utilizing LTE-HSPA carrier aggregation;
receiving, in the network apparatus a request directly via an interface from an LTE base station to perform a setup of a connection between the LTE base station and a user terminal by utilizing LTE-HSPA carrier aggregation;
based on the request, checking, in the network apparatus the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation,
wherein if it is decided, in the network apparatus, to grant the LTE base station the permission to set up the connection between the LTE base station and the user terminal by utilizing LTE-HSPA carrier aggregation, a grant message is transmitted from the network apparatus to the LTE base station the grant message granting the LTE base station the permission to set up the connection between the LTE base station and the user terminal by utilizing LTE-HSPA carrier aggregation.

2. A method as claimed in claim 1, characterized in that the information on the amount of radio network resources that is available to be reserved for user terminals utilizing LTE-HSPA carrier aggregation is received from a radio network controller as a response to an inquiry sent from the network apparatus.

3. A method as claimed in claim 2, characterized in that the inquiry indicates a desired amount of resources, the desired amount of resources being based on QoS information received in the network apparatus from the LTE base station.

4. A method as claimed in claim 1, characterized in that an indication is sent from the network apparatus to the radio network controller that there is an attempt to setup a connection between the LTE base station and a user terminal by utilizing LTE-HSPA carrier aggregation, in order the radio network controller to start to send the information on the amount of radio network resources that is available to be reserved for user terminals utilizing LTE-HSPA carrier aggregation in an unsolicited manner until another indication is sent from the network apparatus to the radio network controller that the network apparatus does not have active connections utilizing LTE-HSPA carrier aggregation anymore.

5. A method as claimed in claim 1, characterized in that the amount of radio network resources that is available to be reserved for user terminals utilizing LTE-HSPA carrier aggregation is expressed as a fraction of the network apparatus's capacity.

6. A method as claimed in claim 1, characterized in that the amount of radio network resources that is available to be reserved for user terminals utilizing LTE-HSPA carrier aggregation is expressed in absolute terms as a guaranteed data throughput that is to be left to HSPA user terminals.

7. A method as claimed in claim 1, characterized in that if in case of congestion the amount of radio network resources that is available to be re-served for user terminals utilizing LTE-HSPA carrier aggregation is reduced by the radio network controller, and if the remaining resources are not sufficient to fulfil the user terminals' QoS requirements, an indication is sent from the network apparatus to the LTE base station to cause the LTE base station to initiate reconfiguration in order to stop using LTE-HSPA carrier aggregation or update QoS parameters of the calls that utilize LTE-HSPA carrier aggregation.

8. An apparatus comprising
at least one processor; and
at least one memory including a computer program code, wherein the at least one memory and the computer program code are configured to, with the at least one processor, cause the apparatus to
receive, information on the amount of radio network resources that is available to be reserved for user terminals utilizing LTE-HSPA carrier aggregation;
receive a request directly via an interface from an LTE base station to perform a setup of a connection between the LTE base station and a user terminal by utilizing LTE-HSPA carrier aggregation;
based on the request, check the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation;
transmit a grant message to the LTE base station if it is decided that the LTE base station is granted the permission to set up the connection between the LTE base station and the user terminal by utilizing LTE-HSPA carrier aggregation, the grant message granting the LTE base station said permission.

9. An apparatus as claimed in claim 8, characterized in that the at least one memory and the computer program code are configured to, with the at least one processor, cause the apparatus to receive the information on the amount of radio network resources that is available to be reserved for user terminals utilizing LTE-HSPA carrier aggregation from a radio network controller as a response to an inquiry sent from the apparatus.

10. An apparatus as claimed in claim 9, characterized in that the inquiry indicates a desired amount of radio network resources, the desired amount of radio network resources being based on QoS information received in the apparatus from the LTE base station.

11. An apparatus as claimed in claim 8, characterized in that the at least one memory and the computer program code are configured to, with the at least one processor, cause the apparatus to send an indication to the radio network controller that there is an attempt to setup a connection between the LTE base station and a user terminal by utilizing LTE-HSPA carrier aggregation, in order the radio network controller to start to send the information on the amount of radio network resources that is available to be reserved for user terminals utilizing LTE-HSPA carrier aggregation in an unsolicited manner until another indication is sent from the apparatus to the radio network controller that the apparatus does not have active connections utilizing LTE-HSPA carrier aggregation anymore.

12. An apparatus as claimed in claim 8, characterized in that the at least one memory and the computer program code are configured to, with the at least one processor, cause the apparatus to, if in case of congestion the amount of radio network resources that is available to be reserved for user terminals utilizing LTE-HSPA carrier aggregation is reduced by the radio network controller, and if the remaining resources are not sufficient to fulfil the user terminals' QoS requirements, send an indication to the LTE base station to cause the LTE base station to initiate reconfiguration in order to stop using LTE-HSPA carrier aggregation or update QoS parameters of the calls that utilize LTE-HSPA carrier aggregation.

13. An apparatus as claimed in claim 8, characterized in that it comprises a legacy base station, such as an HSPA base station node-B.

14. An apparatus comprising a communication control circuitry configured to
receive, information on the amount of radio network resources that is available to be reserved for user terminals utilizing LTE-HSPA carrier aggregation;
receive a request directly via an interface from an LTE base station to perform a setup of a connection between the LTE base station and a user terminal by utilizing LTE-HSPA carrier aggregation;
based on the request, check the information on the amount of radio network resources that is available to be reserved for the user terminals utilizing LTE-HSPA carrier aggregation, in order to decide whether or not to grant the LTE base station a permission to set up the connection between the LTE base station and the user terminal by utilizing LTE-HSPA carrier aggregation;
transmit a grant message to the LTE base station, if it is decided that the LTE base station is granted the permission to set up the connection between the LTE base station and the user terminal by utilizing LTE-HSPA carrier aggregation, the grant message granting the LTE base station said permission.

15. An apparatus comprising
at least one processor; and
at least one memory including a computer program code, wherein the at least one memory and the computer program code are configured to, with the at least one processor, cause the apparatus to
transmit, to a legacy base station, information on the amount of radio network resources that is available to be reserved for user terminals utilizing LTE-HSPA carrier aggregation, in order the legacy base station to be able to decide, based on a request directly received via an interface in the legacy base station from an LTE base station whether or not to grant an LTE base station a permission to set up the connection between the LTE base station and a user terminal by utilizing LTE-HSPA carrier aggregation.

16. An apparatus as claimed in claim 15, characterized in that the at least one memory and the computer program code are configured to, with the at least one processor, cause the apparatus to transmit, to the legacy base station, the information on the amount of radio network resources that is available to be reserved for user terminals utilizing LTE-HSPA carrier aggregation, as a response to an inquiry sent from the legacy base station.

17. An apparatus as claimed in claim 16, characterized in that the inquiry indicates a desired amount of radio network resources, the desired amount of radio network resources being based on QoS information received in the legacy base station from the LTE base station.

18. An apparatus as claimed in claim 15, characterized in that the at least one memory and the computer program code are configured to, with the at least one processor, cause the apparatus to
receive an indication from the legacy base station that there is an attempt to setup a connection between the LTE base station and a user terminal by utilizing LTE-HSPA carrier aggregation; and
start to send, to the legacy base station, the information on the amount of radio network resources that is available to be reserved for user terminals utilizing LTE-HSPA carrier aggregation in an unsolicited manner until another indication is received from the legacy base station that the legacy base station does not have active connections utilizing LTE-HSPA carrier aggregation anymore.

19. An apparatus as claimed in claim 15, characterized in that the at least one memory and the computer program code are configured to, with the at least one processor, cause the apparatus to express the amount of radio net-work resources that is available to be reserved for user terminals utilizing LTE-HSPA carrier aggregation as a fraction of the legacy base station's capacity.

20. An apparatus as claimed in claim 15, characterized in that the at least one memory and the computer program code are configured to, with the at least one processor, cause the apparatus to express the amount of radio net-work resources that is available to be reserved for user terminals utilizing LTE-HSPA carrier aggregation in absolute terms as a guaranteed data throughput that is to be left to HSPA user terminals.

21. An apparatus as claimed in claim 15, characterized in that the at least one memory and the computer program code are configured to, with the at least one processor, cause the apparatus to
reduce, in case of congestion, the amount of radio network resources that is available to be reserved for user terminals utilizing LTE-HSPA carrier aggregation; and
inform the legacy base station on the reduction.

22. An apparatus comprising
at least one processor; and
at least one memory including a computer program code, wherein the at least one memory and the computer program code are configured to, with the at least one processor, cause the apparatus to
transmit directly via an interface to a legacy base station a request to perform a setup of a connection between the apparatus and a user terminal by utilizing LTE-HSPA carrier aggregation;
receive a grant message from the legacy base station, the grant message granting the apparatus a permission to set up the connection between the apparatus and the user terminal by utilizing LTE-HSPA carrier aggregation based on the amount of radio network resources that is available to be reserved for the user terminals utilizing LTE-HSPA carrier aggregation; and
based on the grant message, set up the connection between the apparatus and the user terminal by utilizing LTE-HSPA carrier aggregation.

23. A computer program product comprising program code means adapted to perform steps of claim 1 when the program is run on a computer.
